(19) United States
(12) Patent Application Publication
(10) Pub. No.: US 2004/0028913 A1
(43) Pub. Date: Feb. 12, 2004

(54) Cation-conducting or proton-conducting ceramic membrane based on a hydroxysilylic acid, method for the production thereof and use of the same

(76) Inventors: Volker Hennige, Dulmen (DE); Christian Hying, Rhede (DE); Gerhard Horpel, Nottuln (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/450,247

(22) PCT Filed: Oct. 27, 2001
(86) PCT No.: PCT/EP01/12466

(30) Foreign Application Priority Data
Dec. 13, 2000 (DE) 100 61 920.7

(51) Int. Cl. B32B 9/04

(52) U.S. Cl. 428/446; 428/469; 428/689

(57) ABSTRACT

The invention relates to a cation- and/or proton-conducting membrane, to a process for producing it, and to its use.

The membrane of the invention constitutes a new class of solid proton-conducting membranes. The basis is a porous and flexible ceramic membrane which is described in PCT/EP98/05939. The membrane is infiltrated with a proton-conducting material and then dried and solidified, so that ultimately an impervious, cation/proton-conducting membrane is obtained. The proton-conducting material is a hydroxysilylsulfonic or hydroxysilylphosphonic acid, which is bound into an inorganic network, e.g., SiO₂. The ceramic membrane remains flexible and can be used without problems as a membrane in a fuel cell.

The present invention relates to a cation- and/or proton-conducting membrane which comprises an immobilized hydroxysilyl acid or salt thereof, to a process for producing it, and to its use.

At the present time in the field of fuel cells for the automotive application sector, i.e., for fuel cell operating temperatures of below 200° C., the materials used comprise exclusively polymers or filled polymers (composites). The membranes used most frequently are those made from polymers, such as Nafion® (DuPont, fluorinated framework with a sulfonic acid functionality), and related systems. Another example of a purely organic, proton-conducting polymer are the sulfonated polyether ketones that are described, inter alia, by Hoechst in EP 0 574 791 B1. All of these polymers have the disadvantage that the proton conductivity decreases sharply as the air humidity falls. Accordingly, these membranes have to be swollen in water before being used in the fuel cell. At high temperatures, which are unavoidable in the reformate fuel cell or direct methanol fuel cell (DMFC), these systems can no longer be used, or can be used only with restrictions, since the membrane may easily dry out, with the stated consequences for the proton conductivity.

A further problem arising in connection with the use of polymer membranes in a DMFC is their great permeability for methanol. Because of the crossover of methanol through the membrane to the cathode side, the fuel cell frequently suffers severe performance detractions.

For all these reasons the use of organic polymer membranes for the reformate fuel cell or DMFC is not ideal, and for any widespread use of fuel cells it is necessary to find new solutions.

Although inorganic proton conductors as well are known from the literature (see, for example, “Proton Conductors”, P. Colomban, Cambridge University Press, 1992), the majority of them have conductivities which are too low (such as, for example, the zirconium phosphates) or else the conductivity reaches technically useful levels only at high temperatures, typically at temperatures of more than 500° C., as is the case, for example, with the defect perovskites. Finally, another class of purely inorganic proton conductors, the MHSO₄ family, where M is Rb, Cs or NH₄, although being good proton conductors, are at the same time readily soluble in water, so that they are ruled out of fuel cell applications on account of the fact that water is formed as a product on the cathode side and hence the membrane would be destroyed over time.

Another problem associated with the use of the inorganic proton conductors cited here within the fuel cell is that these inorganic proton conductors are difficult if not completely impossible to produce in the form of a thin membrane film. Since the proton conductor must therefore automatically be manufactured in a very thick form, the overall resistance of the cell, even with high specific conductivity, is still very high. Accordingly, the high fuel cell power densities which are vital to industrial applications, in the automobile, for example, are difficult to realize.

WO99/62620 was first to describe the production of an ion-conducting pervious composite material based on a ceramic, and its use. The steel weave described as the preferred support in WO99/62620 is completely inappropriate, however, for the application of the composite material as a membrane in fuel cells, since when the fuel cell is operated short circuits occur very readily between the electrodes. For use in a fuel cell, moreover, this composite material appears unsuitable on account of the fact that it is referred to as being pervious. For use in a fuel cell, the membrane must be impervious at least for the reaction gases, i.e., H₂, CH₃OH, and O₂.

It is an object of the present invention to provide a membrane having ion conduction properties which combines the advantages of membrane films (high flexibility, low membrane thickness) with those of more or less inorganic proton-conducting systems and which can be used in particular in fuel cells.

Surprisingly it has been found that a membrane comprising as ion-conducting material immobilized hydroxysilyl acids possesses the stated properties, such as high proton conductivity, low membrane thickness, and flexibility, and further possesses a high thermal load-bearing capacity and a low permeability for methanol.

The ion-conducting membrane of the invention is substantially more hydrophilic than the fluorinated hydrophobic polymer membranes customary at the present time. As a result, the water formed on the cathode side can easily diffuse back to the anode, so preventing dryout of the membrane, even at relatively high power densities and service temperatures.

The present invention accordingly provides a cation/proton-conducting membrane which comprises as cation- and/or proton-conducting material immobilized hydroxysilyl acid and/or salts thereof. Particularly preferred salts used are the ammonium, alkali metal, and alkaline earth metal salts.

The present invention likewise provides a process in which a membrane is infiltrated with a hydroxysilyl acid and said acid is immobilized on and in the membrane.

The present invention further provides for the use of such a membrane as a catalyst for acid- or base-catalyzed reactions, as a membrane in fuel cells, or as a membrane in electrodialysis, membrane electrolysis or other electrolysis.

The present invention finally provides a fuel cell comprising as electrolyte membrane a cation/proton-conducting membrane in accordance with the invention or as claimed in claim 1.

The membranes of the invention are distinguished by high cation/proton conductivity even at low water partial pressures and high temperatures. In particular the membranes of the invention can be used even at temperatures above 100° C., preferably from 100 to 200° C.

Through the use of the membranes of the invention it is possible to obtain reformate fuel cells and DMFCs which feature high power densities even at low water partial pressures and high temperatures.

The membrane of the invention and, respectively, a process for producing it, and its use are described in exemplary form below, without being restricted to the embodiments described.

The cation/proton-conducting membranes of the invention can be ceramic or vitreous membranes and are typified by comprising as cation- and/or proton-conducting material at least one immobilized acid from the group of the hydroxysilyl acids or salts thereof. Particularly preferred salts are the ammonium salts, alkali metal salts, and alkaline earth metal salts. The membrane may comprise a composite material based on at least one perforate and pervious support comprising on and inside the support at least one inorganic component essentially comprising at least one compound of a metal, semimetal, mixed metal or phosphorus with at least one element from main groups 3 to 7. With particular preference the composite material comprises on and in the support at least one oxide of the elements Zr, Ti, Al or Si.

In order for the membranes of the invention to be able to be used as electrolyte membranes in fuel cells it is absolutely necessary for the composite material to have ion-conducting layers both on the inside and on both surfaces, since contact between electrolyte and electrodes in what is known as the membrane electrode assembly (MEA) must exist in order to complete the current circuit of the fuel cell. This ion conduction may be undertaken by the immobilized hydroxysilyl acid and/or by the other materials, which are described below.

The support may therefore be composed of an electrically insulating material, such as minerals, glasses, plastics, ceramics or natural substances, for example. Preferably the support comprises special wovens or nonwovens of high-temperature-resistant and highly acid-resistant quartz or glass. The glass preferably comprises at least one compound from the group consisting of SiO₂, Al₂O₃ and MgO. In another version the support is composed of a woven or nonwoven Al₂O₃, ZrO₂, TiO₂, Si₃N₄, or SiC ceramic. In order to minimize the overall resistance of the electrolyte membrane this support preferably combines a very high porosity with a low thickness of less than 100 μm, preferably less than 50 μm, and very preferably less than 20 μm.

In a first step in accordance with WO 99/15262, for example, the perforate support can be converted into a mechanically and thermally stable, pervious ceramic composite material which conducts neither electricity nor ions.

Composite materials in accordance with WO 99/15262 feature, for example, supports made of at least one material selected from glasses, ceramics, minerals, plastics, amorphous substances, natural products, composites, or from at least one combination of said materials. The supports which may comprise the aforementioned materials may have been modified by a chemical, thermal or mechanical treatment method or by a combination of the treatment methods. The membrane preferably comprises a support comprising at least interwoven, interbonded, felted or ceramically bound fibers or at least sintered or bonded shapes, spheres or particles. It may be advantageous for the support to comprise fibers of at least one material selected from ceramics, glasses, minerals, plastics, amorphous substances, composites, and natural products or fibers of at least one combination of said materials, such as asbestos, glass fibers, rockwool fibers, polyamide fibers, coconut fibers or coated fibers, for example. It is preferred to use supports comprising interwoven fibers of glass or quartz, the woven preferably being composed of 11-tex yarns having 5-50 warp and weft threads and preferably 20-28 warp threads and 28-36 weft threads. Very preferably use is made of 5.5-tex yarns having 10-50 warp and weft threads and preferably 20-28 warp and 28-36 weft threads.

The composite materials comprise at least one inorganic component on and in the support. This inorganic component may comprise at least one compound of at least one metal, semimetal or mixed metal with at least one element from main groups 3 to 7 of the Periodic Table, or at least one mixture of said compounds. The compounds of the metals, semimetals or mixed metals may comprise at least elements from the transition group elements and from main groups 3 to 5 or at least elements from the transition group elements or from main groups 3 to 5, these compounds being used with preference in a particle size of from 0.001 to 25 μm. The inorganic component preferably comprises at least one compound of an element from transition groups 3 to 8 or at least one element from main groups 3 to 5 with at least one of the elements Te, Se, S, O, Sb, As, P, N, Ge, Si, C, Ga, Al or B or at least one compound of an element from transition groups 3 to 8 and at least one element from main groups 3 to 5 with at least one of the element Te, Se, S, O, Sb, As, P, N, Ge, Si, C, Ga, Al or B, or a mixture of said compounds. With particular preference the inorganic component comprises at least one compound of at least one of the elements Sc, Y, Ti, Zr, V, Nb, Cr, Mo, W, Mn, Fe, Co, B, Al, Ga, In, Tl, Si, Ge, Sn, Pb, P, Sb or Bi with at least one of the elements Te, Se, S, O, Sb, As, P, N, C, Si, Ge or Ga, such as, for example, TiO₂, Al₂O₃, SiO₂, ZrO₂, Y₂O₃, B₄C, SiC, Fe₃O₄, Si₃N₄, BN, SiP, nitrides, sulfates, phosphides, silicides, spinels or perovskites.

Prior to processing to the composite material it is preferred for at least one inorganic component to be present in the form of a particle size fraction having a particle size of from 1 to 250 nm and/or having a particle size of from 260 to 10 000 nm. In one special embodiment the composite material comprises at least one inorganic component in the form of a three-dimensional network having a specific surface area of up to 1 000 m²/g and having pore radii of 0.5-10 nm. This component preferably comprises at least one compound from the group consisting of Al₂O₃, ZrO₂, SiO₂, TiO₂, and P₂O₅.

It may be advantageous if the composite material used has at least two particle size fractions of at least one inorganic component. It may also be advantageous if the composite material has at least two particle size fractions of at least two inorganic components. The particle size ratio may be from 1:1 to 1:10 000, preferably from 1:1 to 1:100. The proportion of the particle size fractions in the composite material may amount preferably to from 0.01:1 to 1:0.01.

The hydroxysilyl acid can be used directly or in the form of a precursor, i.e., of a derivative (e.g., alkoxide).

Useful hydroxysilyl acids, their salts or their precursors, such as alkoxides, are organosilicon compounds of the general formula

[(RO)_{y}(R²)_{z}Si-{R¹-SO₃⁻}ₐ]ₓM^{x+} (I)

or

[(RO)_{y}(R²)_{z}Si-{R¹-O_{b}—P(O_{c}R³)O₂⁻}ₐ]ₓM^{x+} (II)

where R¹ is a linear or branched alkyl or alkylene group having from 1 to 12 carbon atoms, a cycloalkyl group having from 5 to 8 carbon atoms or a unit of the general formula

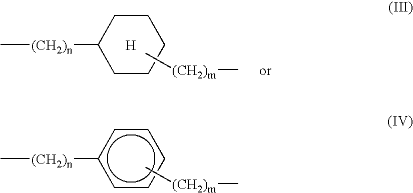

where n and m are each a number from 0 to 6,

M is an H⁺, an NH₄⁺ or a metal cation having a valence x of from 1 to 4, y is from 1 to 3, z is from 0 to 2, and a is from 1 to 3, with the proviso that y+z=4−a,

b and c are 0 or 1,

R and R² are identical or different and are methyl, ethyl, propyl or butyl radicals or H, and R³ is the same as M or is a methyl, ethyl, propyl or butyl radical.

Preferred hydroxysilyl acids and their precursors (derivatives) are trihydroxysilylpropylsulfonic acid, trihydroxysilylpropylmethylphosphonic acid, or dihydroxysilylpropyldisulfonic acid, or salts thereof.

The existing hydroxyl groups or hydroxyl groups produced by hydrolysis serve to attach the silyl acids to the inorganic composite material. As a result of this attachment the acid or salt thereof is immobilized, i.e., made insoluble. Through an appropriate choice of the tri- (network formers), di- (chain formers), and mono-hydroxysilyl acid (terminal chain member) and through the addition of further sol formers it is possible to set with precision the structure of the ion-conducting material under construction. Examples of suitable sol formers are the hydrolyzed precursors of SiO₂, Al₂O₃, P₂O₅, TiO₂ or ZrO₂.

EP 0 771 589, EP 0 765 897, and EP 0 582 879 disclose trihydroxysilyl acids. Those publications described the preparation of shaped acid catalysts based on trihydroxysilylpropylsulfonic acid and trihydroxysilylpropyl mercaptan.

It may be advantageous if the membrane of the invention comprises at least one further ion-conducting compound selected from the group consisting of iso- and heteropolyacids, zeolites, mordenites, aluminosilicates, β-aluminas, zirconium, titanium, and cerium phosphates, phosphonates or sulfoarylphosphonates, antimony acids, phosphorus oxides, sulfuric acid, perchloric acid, and salts thereof. In one particularly preferred variant the membrane also comprises nanoscale powders from the group consisting of SiO₂, Al₂O₃, ZrO₂, and TiO₂.

The membrane of the invention conducts cations and/or protons at a temperature of from −40° C. to 300° C., preferably from −10 to 200° C. If a flexible composite material is used in producing the membrane of the invention, the membrane of the invention itself is flexible and depending on the composite material used can be bent down to a smallest radius of 25 mm, preferably 10 mm, very preferably 5 mm.

In a further embodiment of the process the membrane is infiltrated with a solution or suspension which in addition to the hydroxylsilyl acid, its salts or precursors further comprises at least one other proton- or cation-conducting material.

The composite material may also be infiltrated with a solution, sol or suspension which in addition to the hydroxysilyl acid, its salts or precursors further comprises at least one further material based on a hydrolyzed or hydrolyzable compound of a metal or semimetal, which contributes to immobilization of the hydroxysilyl acid.

Again in dependence on the composite material employed, the membrane has a thickness of less than 200 μm, preferably less than 100 μm, and very preferably less than 50 or 20 μm.

The production of mechanically and thermally stable and yet pervious ceramic composite materials is described in detail, for example, in WO 99/15262. In contrast to the composite materials described therein, however, the composite materials suitable for the process of this invention only include those which are not electrically conducting.

In order to immobilize the hydroxysilyl acid in and on the membrane said membrane is treated or infiltrated at least with the hydroxysilyl acid, where appropriate in aqueous or alcoholic solution. In addition it is also possible to include the ion-conducting compounds already mentioned. They can be present in dissolved form or in suspension in the solution used for the coating.

In any case the hydroxysilyl acid at least must be immobilized in and on a membrane. In accordance with the process of the invention this can be accomplished thermally, in which case the membrane infiltrated with hydroxysilyl acid is treated first at a temperature of from 0 to 50° C. and subsequently the hydroxysilyl acid is immobilized at a temperature of from 20 to 250° C.

The immobilization of the hydroxysilyl acid—together where appropriate with the other ion-conducting compounds—is frequently accompanied by the formation first of sol and then of gel. Accordingly, infiltration can be carried out not only with a solution but also with a sol.

The porous composite material may also be infiltrated with a sol which in addition to the hydroxysilyl acid sol former further comprises at least one hydrolyzed compound selected from the group consisting of metal nitrates, metal chlorides, metal carbonates, metal alkoxides, and semimetal oxides. A particularly preferred sol former used is at least one hydrolyzed compound selected from the alkoxides, acetylacetonates, nitrates, and chlorides of the elements Ti, Zr, Al, and Si.

The sols can be obtained by hydrolyzing at least one of the aforementioned hydrolyzable compounds, preferably at least one metal compound, semimetal compound or mixed metal compound, with at least one liquid, solid or gas, in which case it can be advantageous if the liquid used comprises, for example, water, alcohol, a base or an acid, the solid used comprises ice, or the gas used comprises water vapor or at least one combination of these liquids, solids or gases. It may also be advantageous to introduce the compound to be hydrolyzed into alcohol, a base or an acid or a combination of these liquids prior to the hydrolysis.

It may be advantageous to conduct the hydrolysis of the compounds to be hydrolyzed using at least half the molar ratio of water, water vapor or ice, based on the hydrolyzable group of the compound to be hydrolyzed.

The hydrolyzed compound can be peptized by treatment with at least one organic or inorganic acid, preferably with an organic or inorganic acid having a concentration of from 10 to 60%, more preferably with a mineral acid selected from sulfuric acid, hydrochloric acid, perchloric acid, phosphoric acid, and nitric acid, or a mixture of these acids.

It is possible not only to use sols prepared as described above but also commercially customary sols, such as titanium or zirconium nitrate sol, zirconium acetate sol or silica sol, for example.

It may be advantageous if either instead of the sol former or in addition thereto at least one solid inorganic, preferably proton-conducting, component is suspended in the sol comprising the hydroxysilyl acid. Preference is given to suspending an inorganic component which comprises at least one compound selected from metal compounds, semimetal compounds, mixed metal compounds, and metal mixed compounds with at least one of the elements from main groups 3 to 7, or at least one mixture of these compounds. Particular preference is given to suspending in the sol at least one inorganic proton-conducting component selected from the group of the iso- or heteropolyacids, such as 12-tungstophosphoric acid (WPA), silicotungstic acid, zirconium, titanium or cerium phosphates, phosphonates or sulfoarylphosphonates, antimony acids, phosphorus oxides, Aerosil (SiO₂), nanoscale Al₂O₃, TiO₂ or ZrO₂ powders, zeolites, mordenites, aluminosilicates, and β-aluminas.

Through the appropriate choice of the particle size of the suspended compounds as a function of size of the pores, holes or interstices in the porous ceramic composite material it is possible to optimize the cracklessness in the membrane of the invention.

In another variant of the process of the invention the sol further comprises a strong liquid acid, such as sulfuric acid or perchloric acid, which can likewise be immobilized by being bound into the inorganic network.

The infiltration of the sol in and on the membrane can take place, for example, by printing on, pressing on, pressing in, rolling on, roller application, knife coating, spreading on, dipping, spraying, spray application or pouring of the sol onto the membrane or composite material. It is, however, also possible to infiltrate the composite material or membrane with the sol by dipping or vacuum infiltration.

The sol infiltrated into the composite material is heated to the stated temperatures, at which it gels. This operation may last for from 0.1 to 72 hours. Preferably the sol is gelled in the composite material within from 0.1 to 0.5 hours. The resultant gel is subsequently immobilized—i.e., solidified and, in extreme cases, made water-insoluble—at a temperature of from 20 to 250° C., preferably from 150 to 200° C.

The proton/cation-conducting membrane of the invention can be employed widely in industry and can be utilized for a very wide variety of applications. Mention may be made in particular here of applications in electrodialysis as cation exchange membranes, and also of application as a membrane/diaphragm in electrolysis cells, including membrane electrolysis cells.

Further fields of application are situated in the sector of energy generation using fuel cells. The membrane of the invention can be used as an electrolyte membrane in a fuel cell. Such fuel cells can be operated at a higher temperature than fuel cells having an electrolyte membrane based on a polymer membrane. Accordingly the fuels can be, for example, alcohols or hydrocarbons (directly or indirectly via a reforming step). CO poisoning of the electrode which is catalytically active on the anode side does not occur at these elevated temperatures (>120° C.).

However, there are also a whole range of electrochemical or catalyzed reactions which take place on and/or are catalyzed by ion-conducting materials. The membrane of the invention is therefore also suitable for use as a catalyst for acid- or base-catalyzed reactions.

The proton/cation-conducting membrane of the invention and the process for producing it are described by means of the following examples, without being restricted to them.

### EXAMPLE 1

### Non-ion-conducting Composite Material

120 g of zirconium tetraisopropoxide are stirred with 140 g of deionized ice with vigorous stirring until the precipitate which forms is very finely divided. Following the addition of 100 g of 25% strength hydrochloric acid the mixture is stirred until the phase becomes clear, 280 g of α-alumina of type CT3000SG from Alcoa, Ludwigshafen, Del. are added and the mixture is stirred for several days until the aggregates have been broken up.

This suspension is subsequently applied in a thin layer to a glass weave (11-tex yarn with 28 warp threads and 32 weft threads) and solidified at 550° C. within 5 seconds.

### EXAMPLE 2

### Production of a Proton-conducting Membrane

10 ml of anhydrous trihydroxysilylpropylsulfonic acid, 30 ml of ethanol and 5 ml of water are mixed by stirring. 40 ml of TEOS (tetraethyl orthosilicate) are slowly added dropwise to this mixture with stirring. In order to bring about a certain degree of condensation this sol is stirred in a closed vessel for 24 hours. The composite material from Example 1 is immersed in this sol for 15 minutes. Thereafter the sol in the saturated membrane is gelled in air for 60 minutes and dried.

The gel-filled membrane is dried at a temperature of 200° C. for 60 minutes, so that the gel solidifies and is made water-insoluble. In this way an impervious membrane is obtained which has a proton conductivity at room temperature and normal ambient air of about 2·10⁻³ S/cm.

### EXAMPLE 3

### Production of a Proton-conducting Membrane

25 g of tungstophosphoric acid are dissolved in 50 ml of the sol from Example 2. The composite material from Example 1 is immersed in this sol for 15 minutes. The subsequent procedure is then as in Example 2.

### EXAMPLE 4

### Production of a Proton-conducting Membrane

100 ml of titanium isopropoxide are added dropwise with vigorous stirring to 1 200 ml of water. The resulting precipitate is aged for 1 hour, then 8.5 ml of concentrated HNO₃ are added and the precipitate is peptized at boiling for 24 hours. 50 g of tungstophosphoric acid are dissolved in 25 ml of the sol. A further 25 ml of trihydroxysilylpropylsulfonic acid are added to this solution, which is stirred at room temperature for 1 hour more. The composite material from Example 1 is immersed in this sol for 15 minutes. The subsequent procedure is as in Example 2.

### EXAMPLE 5

### Production of a Proton-conducting Membrane

Trihydroxysilylmethylphosphonic acid dissolved in a little water is diluted with ethanol. The same amount of TEOS is added to the solution, and stirring is continued briefly. The composite material from Example 1 is immersed in this sol for 15 minutes. The subsequent procedure is as in Example 2.

What is claimed is:

1. A cation/proton-conducting membrane comprising
as cation- and/or proton-conducting materials at least one immobilized hydroxysilyl acid and/or salt thereof.

2. A membrane as claimed in claim 1, which
is ceramic or vitreous.

3. A membrane as claimed in claim 1 or 2, comprising
a composite material based on a perforate and pervious support comprising on and inside said support at least one inorganic component essentially comprising at least one compound of a metal, semimetal, mixed metal or phosphorus with at least one element from main groups 3 to 7.

4. A membrane as claimed in claim 3, wherein
the support comprises a woven or nonwoven made of fibers of one or more materials selected from the group consisting of glasses, ceramics, natural substances, plastics, and minerals.

5. A membrane as claimed in any of claims 1 to 4, which
conducts cations and/or protons at a temperature of from −40° C. to 300° C.

6. A membrane as claimed in any of claims 1 to 5, wherein
use is made as hydroxysilyl acid or precursor thereof of an organosilicon compound of the general formula
[(RO)_{y}(R²)_{z}Si-{R¹-SO₃⁻}ₐ]ₓM^{x+} (I)
or
[(RO)_{y}(R²)_{z}Si-{R¹-O_{b}—P(O_{c}R³)O₂⁻}ₐ]ₓM^{x+} (II)
where R¹ is a linear or branched alkyl or alkylene group having from 1 to 12 carbon atoms, a cycloalkyl group having from 5 to 8 carbon atoms or a unit of the general formula 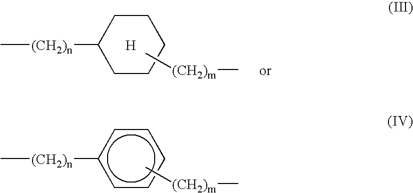
where n and m are each a number from 0 to 6,
M is an H⁺, an NH₄⁺ or a metal cation having a valence x of from 1 to 4,
y is from 1 to 3,
z is from 0 to 2, and a is from 1 to 3, with the proviso that y+z=4−a,
b and c are 0 or 1,
R and R² are identical or different and are methyl, ethyl, propyl or butyl radicals or H, and R³ is the same as M or is a methyl, ethyl, propyl or butyl radical.

7. A membrane as claimed in claim 6, wherein
use is made as hydroxysilyl acid of trihydroxysilylpropylsulfonic acid, trihydroxysilylpropylmethylphosphonic acid or dihydroxysilylpropyldisulfonic acid or salts thereof.

8. A membrane as claimed in any of claims 1 to 7, wherein
the hydroxysilyl acid is immobilized with a hydrolyzed compound of phosphorus or with a hydrolyzed compound from the group of the nitrates, oxynitrates, chlorides, oxychlorides, carbonates, alkoxides, acetates, and acetylacetonates of the metals or semimetals.

9. A membrane as claimed in claim 8, wherein
the hydroxysilyl acid is immobilized with a hydrolyzed compound obtained from titanium propoxide or ethoxide, tetramethyl or tetraethyl orthosilicate (TMOS, TEOS), zirconium nitrate, oxynitrate, propoxide, acetate or acetylacetonate, or methyl phosphate.

10. A membrane as claimed in any of claims 1 to 9, comprising
at least one further ion-conducting compound selected from the group consisting of nanoscale Al₂O₃, ZrO₂, TiO₂ and SiO₂ powders, iso- and heteropolyacids, zeolites, mordenites, aluminosilicates, β-aluminas, zirconium, titanium, and cerium phosphates, phosphonates, and sulfoarylphosphonates, antimony acids, phosphorus oxides, sulfuric acid, and perchloric acid or salts thereof.

11. A membrane as claimed in any of claims 1 to 10, which
is flexible.

12. A membrane as claimed in any of claims 1 to 11, which
can be bent down to a smallest radius of 25 mm.

13. A membrane as claimed in any of claims 1 to 12, which
has a thickness of less than 200 μm.

14. A process for producing a cation/proton-conducting membrane, which comprises
infiltrating said membrane with a hydroxysilyl acid, salt thereof or precursor(s) thereof and immobilizing said acid, salt or precursor(s) on and in said membrane.

15. A process as claimed in claim 14, wherein
the membrane is ceramic or vitreous.

16. A process as claimed in claim 14 or 15, wherein
the membrane comprises a composite material based on a perforate and pervious support comprising on and inside said support at least one inorganic component essentially comprising at least one compound of a metal, semimetal, mixed metal or phosphorus with at least one element from main groups 3 to 7.

17. A process as claimed in claim 16, wherein
the support comprises a woven or nonwoven made of fibers of one or more materials selected from the group consisting of glasses, ceramics, natural substances, plastics, and minerals.

18. A process as claimed in any of claims 14 to 17, wherein
the membrane conducts cations and/or protons at a temperature of from −40° C. to 300° C.

19. A process as claimed in any of claims 14 to 18, wherein
use is made as hydroxysilyl acid or precursor thereof of an organosilicon compound of the general formula
[(RO)_{y}(R²)_{z}Si-{R¹-SO₃⁻}ₐ]ₓM^{x+} (I)
or
[(RO)_{y}(R²)_{z}Si-{R¹-O_{b}—P(O_{c}R³)O₂⁻}ₐ]ₓM^{x+} (II)
where R¹ is a linear or branched alkyl or alkylene group having from 1 to 12 carbon atoms, a cycloalkyl group having from 5 to 8 carbon atoms or a unit of the general formula 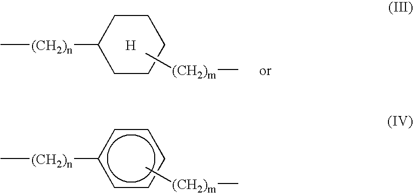
where n and m are each a number from 0 to 6,
M is an H⁺, an NH₄⁺ or a metal cation having a valence x of from 1 to 4,
y is from 1 to 3,
z is from 0 to 2, and a is from 1 to 3, with the proviso that y+z=4−a,
b and c are 0 or 1,
R and R² are identical or different and are methyl, ethyl, propyl or butyl radicals or H, and R³ is the same as M or is a methyl, ethyl, propyl or butyl radical.

20. A process as claimed in claim 19, wherein
use is made as hydroxysilyl acid of trihydroxysilylpropylsulfonic acid, trihydroxysilylpropylmethylphosphonic acid or dihydroxysilylpropyldisulfonic acid or salts thereof.

21. A process as claimed in any of claims 14 to 20, wherein
the hydroxysilyl acid is immobilized with a hydrolyzed compound of phosphorus or with a hydrolyzed compound from the group of the nitrates, oxynitrates, chlorides, oxychlorides, carbonates, alkoxides, acetates, and acetylacetonates of the metals or semimetals.

22. A process as claimed in claim 21, wherein
the hydroxysilyl acid is immobilized with a hydrolyzed compound obtained from titanium propoxide or ethoxide, tetramethyl or tetraethyl orthosilicate (TMOS, TEOS), zirconium nitrate, oxynitrate, propoxide, acetate or acetylacetonate, or methyl phosphate.

23. A process as claimed in any of claims 14 to 22, wherein
the membrane is infiltrated with a solution, sol or suspension which in addition to the hydroxysilyl acid, its salts or precursors further comprises at least one further material based on a hydrolyzed or hydrolyzable compound of a metal or semimetal, which contributes to immobilizing the hydroxysilyl acid.

24. A process as claimed in any of claims 14 to 23, where
the membrane is infiltrated with a solution or suspension which in addition to the hydroxysilyl acid, its salts or precursors further comprises at least one further proton- or cation-conducting material.

25. A process as claimed in any of claims 14 to 24, wherein
the membrane in addition to the immobilized hydroxylsilyl acid comprises least one further ion-conducting compound selected from the group consisting of nanoscale Al₂O₃, ZrO₂, TiO₂ and SiO₂ powders, iso- and heteropolyacids, zeolites, mordenites, aluminosilicates, β-aluminas, zirconium, titanium, and cerium phosphates, phosphonates, and sulfoarylphosphonates, antimony acids, phosphorus oxides, sulfuric acid, and perchloric acid or salts thereof.

26. A process as claimed in any of claims 14 to 25, wherein
the membrane is flexible.

27. A process as claimed in any of claims 14 to 26, wherein
the membrane can be bent down to a smallest radius of 25 mm.

28. A process as claimed in any of claims 14 to 27, wherein
the membrane has a thickness of less than 200 μm.

29. A process as claimed in at least one of claims 15 to 28, wherein
the membrane infiltrated with hydroxysilyl acid is first treated at a temperature of from 0 to 50° C. and then the hydroxysilyl acid is immobilized at a temperature of from 20 to 250° C.

30. The use of a membrane as claimed in at least one of claims 1 to 13 as a catalyst for acid- or base-catalyzed reactions.

31. The use of a membrane as claimed in at least one of claims 1 to 13 as a membrane in fuel cells.

32. The use of a membrane as claimed in at least one of claims 1 to 13 as a membrane in electrodialysis, membrane electrolysis or other electrolysis.

33. A fuel cell comprising
as electrolyte membrane a cation/proton-conducting membrane as claimed in any of claims 1 to 13.
